(19) United States
(12) Patent Application Publication
(10) Pub. No.: US 2017/0193459 A1
(43) Pub. Date: Jul. 6, 2017

(54) SCHEDULER RESPONSIVE TO PERSONALITY PROFILE

(71) Applicant: INTERNATIONAL BUSINESS MACHINES CORPORATION, ARMONK, NY (US)

(72) Inventors: MARCO P. CRASSO, BUENOS AIRES, AR (US); PABLO J. PEDEMONTE, BUENOS AIRES, AR (US)

(21) Appl. No.: 14/989,245

(22) Filed: Jan. 6, 2016

(51) Int. Cl. G06Q 10/10; G06F 17/30; G06F 17/27

(52) U.S. Cl. CPC G06Q 10/1097; G06F 17/274; G06F 17/30702

(57) ABSTRACT

A calendar scheduler that automatically schedules future task appointments by correlating task attributes to user personality traits. A morningness trait or an eveningness trait is selected for application to a user as a function of personality trait data of the user. A main task verb of an appointment request is mapped to a matching verb associated with one of a plurality of cognitive domain taxonomy levels, wherein the cognitive domain taxonomy levels have different complexity values and are each associated with different matching verbs. An open slot within an electronic calendar is selected for scheduling the appointment request as a function of the complexity value of the cognitive domain taxonomy level associated with a verb mapped to the main task verb, a correlation of workplace co-worker occupancy to a preference of the user, and to a time within a timeframe of the selected morningness or eveningness trait.

### BACKGROUND

Electronic calendars are applications and programs executed by programmable devices that dynamically define an interactive scheduling calendar wherein users that have permission to access the calendar may set and revise appointments and events in real-time. The Internet and portable devices have made electronic calendars ubiquitous, not only for business people but also for ordinary users. Electronic calendars may provide a variety of different features, including sharing events among multiple users, automatic reminders, and resource allocation support, including the ability to make or accept a meeting room reservation. Electronic calendars commonly provide support for organizing tasks, mainly by pinpointing schedule conflicts.

Some calendar applications offer pro-active, enhanced or personalized scheduling assistance. For example, an electronic calendar may aggregate historic appointment data for a user over time, and use this data to identify an appointment or event contained in the historic data that has attributes that indicate it will likely occur in the future (for example, a bill payment to a payee that occurs on or around the same time of month every month, a birthday party, etc.) The electronic calendar may use this data to suggest entry of a future appointment for the same or similar appointment, at an event date or time that correlates with the historic data, or is extrapolated forward from a periodic time period associated with historic occurrences of the event into the future (for example, suggesting payment to the payee on the same, upcoming day of this month as last month, entering a birthday that was observed last year, etc.).

### BRIEF SUMMARY

In one aspect of the present invention, a method for a calendar scheduler that automatically schedules a future task appointment by correlating task attributes to user personality traits include selecting one of a morningness trait and an eveningness trait for application to a user as a function of personality trait data for the user, wherein selection of the eveningness trait is responsive to an indication in the personality trait data that the user prefers to perform complex tasks at times other than during morning times. A main task verb of an appointment request is mapped to a matching verb associated with one of a plurality of cognitive domain taxonomy levels, wherein the cognitive domain taxonomy levels have different complexity values relative to each other and are each associated with different verbs for matching to the main task verb. In response to the complexity value of the cognitive domain taxonomy level associated with the matching verb mapped to the main task verb meeting a minimum complexity threshold, an open slot within an electronic calendar is selected for scheduling the appointment request as a function of a correlation of co-worker occupancy of a workplace of the user during the selected open slot to a preference of the user to work with co-workers, and to a time of the selected open slot within a timeframe of the selected morningness or eveningness trait.

In another aspect, a system has a hardware processor in circuit communication with a computer readable memory and a computer-readable storage medium having program instructions stored thereon. The processor executes the program instructions stored on the computer-readable storage medium via the computer readable memory and thereby selects one of a morningness trait and an eveningness trait for application to a user as a function of personality trait data for the user, wherein selection of the eveningness trait is responsive to an indication in the personality trait data that the user prefers to perform complex tasks at times other than during morning times. A main task verb of an appointment request is mapped to a matching verb associated with one of a plurality of cognitive domain taxonomy levels, wherein the cognitive domain taxonomy levels have different complexity values relative to each other and are each associated with different verbs for matching to the main task verb. In response to the complexity value of the cognitive domain taxonomy level associated with the matching verb mapped to the main task verb meeting a minimum complexity threshold, an open slot within an electronic calendar is selected for scheduling the appointment request as a function of a correlation of co-worker occupancy of a workplace of the user during the selected open slot to a preference of the user to work with co-workers, and to a time of the selected open slot within a timeframe of the selected morningness or eveningness trait.

In another aspect, a computer program product for a calendar scheduler that automatically schedules a future task appointment by correlating task attributes to user personality traits has a computer-readable storage medium with computer readable program code embodied therewith. The computer readable hardware medium is not a transitory signal per se. The computer readable program code includes instructions for execution which cause the processor to select one of a morningness trait and an eveningness trait for application to a user as a function of personality trait data for the user, wherein selection of the eveningness trait is responsive to an indication in the personality trait data that the user prefers to perform complex tasks at times other than during morning times. A main task verb of an appointment request is mapped to a matching verb associated with one of a plurality of cognitive domain taxonomy levels, wherein the cognitive domain taxonomy levels have different complexity values relative to each other and are each associated with different verbs for matching to the main task verb. In response to the complexity value of the cognitive domain taxonomy level associated with the matching verb mapped to the main task verb meeting a minimum complexity threshold, an open slot within an electronic calendar is selected for scheduling the appointment request as a function of a correlation of co-worker occupancy of a workplace of the user during the selected open slot to a preference of the user to work with co-workers, and to a time of the selected open slot within a timeframe of the selected morningness or eveningness trait.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing node according to an embodiment of the present invention.

FIG. 2 depicts a cloud computing environment according to an embodiment of the present invention.

FIG. 3 depicts a computerized aspect according to an embodiment of the present invention.

FIG. 4 is a flow chart illustration of a method or process according to an aspect of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

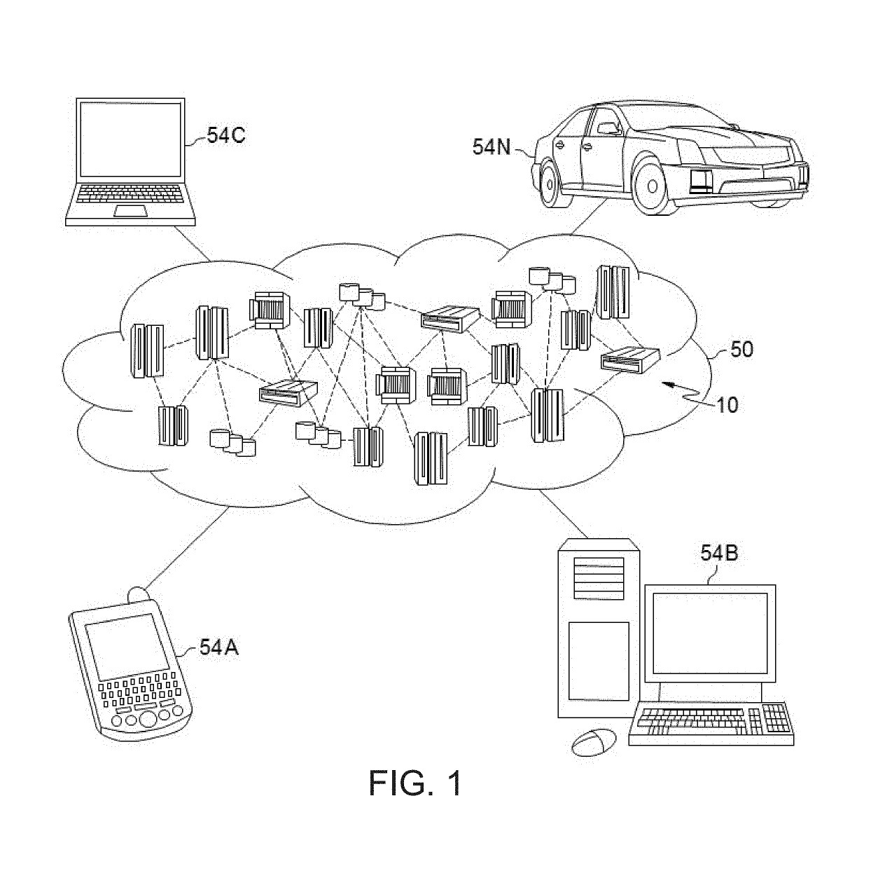

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

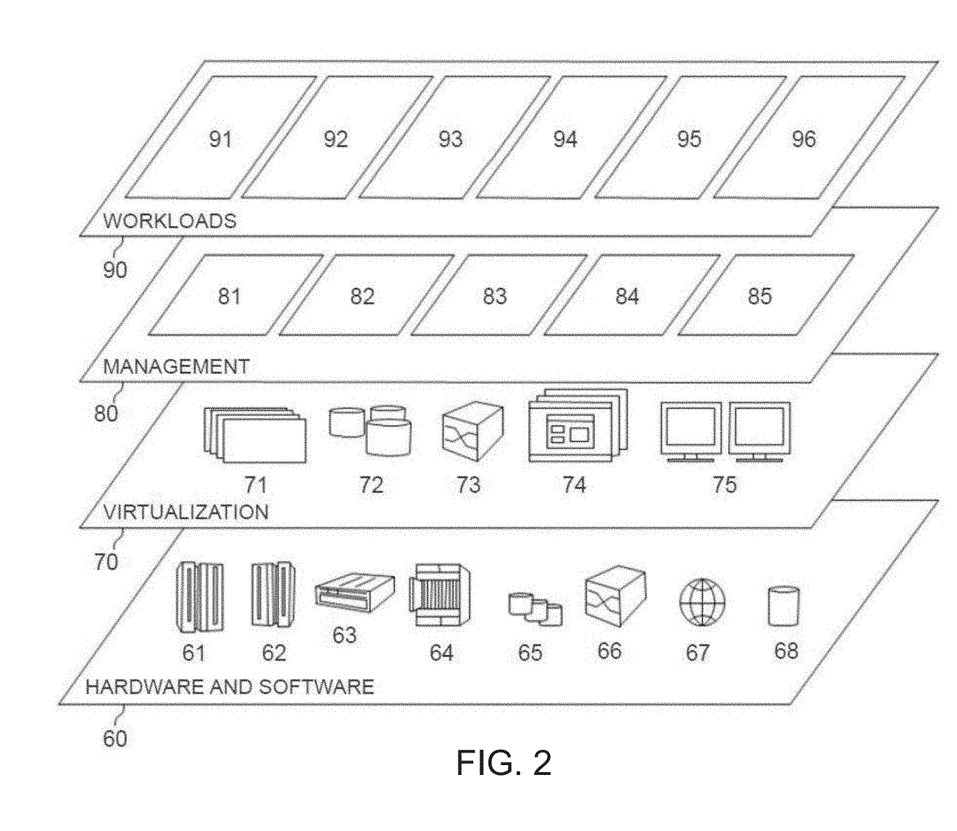

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing 96 for a calendar scheduler that automatically schedules a future task appointment by correlating attributes of the task to personality traits of the user as described below.

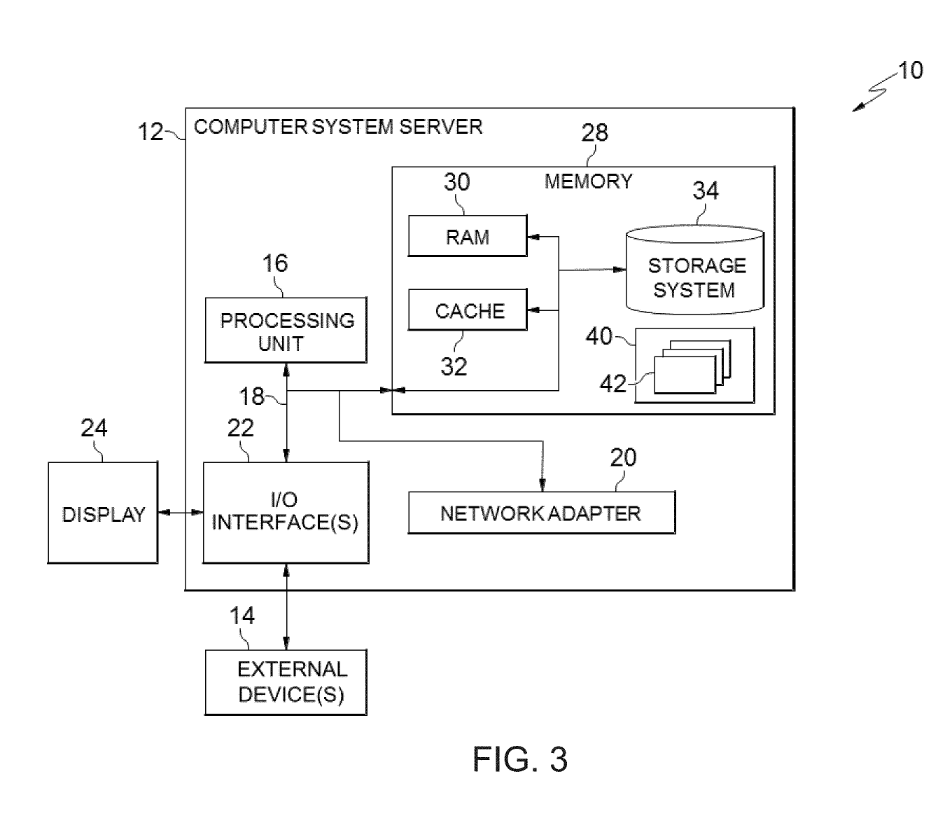

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Prior art electronic calendar applications may use a variety of techniques to pro-actively schedule or suggest appointment dates and times. They may perform text analysis of message body content to identify a suggested date and time, for example creating a hyperlink from dates or days of the week that appear within email message content, wherein selection of the hyperlink by a user automatically generates an appointment at the specified time or day. They may default to suggesting first available appointments that are indicated as open, for example within the next workday of the user. Systems may extrapolate from historic appointment activity to suggest or set appointments for similar or identical tasks at the same times of day or days of the week or month, such as setting up an automatic payment for a reoccurring utility bill on the same day of each month. Systems may also consider circadian rhythm inputs in setting appointments, for example avoiding meetings right after lunch or setting task appointments for peak productivity hours, such as between 4:00 PM and 6:00 PM for a current time zone of an employee.

However, such scheduling approaches may be suboptimal for some users and some tasks. For example, a user may need to schedule the task of writing an introduction section of a research paper for completion by a certain time period, such as the end of the present week. A prior art electronic calendar scheduler may select and suggest the next free slot in the user's workday for the present week, such as the first open time period the next morning. In some aspects if the user accepts this suggestion, the choice may be recorded and used as a basis to propagate additional suggested appointments at similar times and days into the future, such as the same time for the same day of each week (at 9:00 AM, or other first-open morning slot, every Wednesday, or the 15^{th} of every month, or the 15^{th} of the first month of each quarter, etc.).

However, the task associated with the suggested appointment is “writing,” a task that demands the application of existing knowledge. The research article may be complex, requiring significant effort and attention to detail by the user, efforts well beyond other, simpler writing tasks, such as a thank you note, a message to confirm details for a meeting request, etc. The user may generally prefer to perform this type task in the early afternoon, after daily routine work is completed and right after lunch, even though general circadian rhythm-based aspects would avoid such a time slot. The user may also prefer to avoid crowded work environments for creative tasks such as this one: however, the morning hour slots at the relevant workplace that are determined as best-available by the prior art scheduler may have high occupancy rates relative to other times of day, engendering many non-productive co-worker interactions. The user may also prefer to tackle tasks that demand some types of effort and attention at night, away from an office environment entirely, which is counter to the scheduling of a majority of other tasks indicated by historic scheduling activity of the user. Thus, a prior art scheduler that chooses or sets a first-available morning slot for this task, or suggests future appointments for this task at similar morning times within busy workplace locations as extrapolated from a previous appointment acceptance, will generate a suggestion that is not optimal to enabling the user to complete the task or otherwise unsatisfactory to the user.

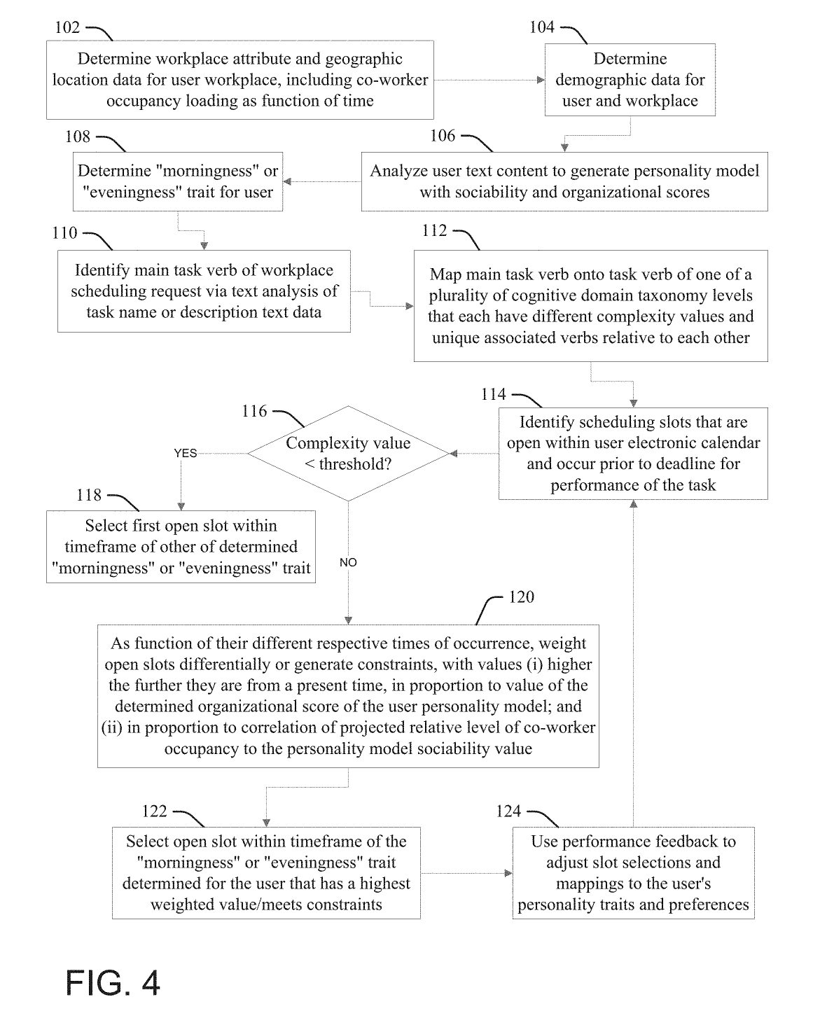

FIG. 4 (or “FIG. 4”) illustrates a computer implemented (method or process) of an aspect of the present invention for a calendar scheduler that automatically schedules a future task appointment (or suggestion or reminder for future appointment) within an electronic calendar of a user by correlating attributes of the task to personality traits of the user, and selecting an optimal time of day for execution of the task as a function of the combination of the correlated task attributes and the user personality traits. A processor (for example, a central processing unit (CPU)) executes code, such as code installed on a storage device in communication with the processor, and thereby performs the process step elements illustrated in FIG. 4.

Thus, at 102 workplace attribute and geographic location data is determined or acquired for a workplace of a user. The workplace attribute data includes type of workplace (for example, office, factory, home office, shared workspace, etc.) workday hours (for example, 9:00 AM to 5:00 PM, or flexible range of possible working hours, a minimum monthly or yearly quota of hours that may be executed at any time of day, etc.), and co-worker occupancy loading as a function of time periods, including in correlation with the workday hour data. The co-worker occupancy loading determines relative differences in numbers of co-workers on-site for different times, such as during the normal workday versus before and after, between shifts and even portions of the same shift: for example, numbers during respective morning or afternoon portions where sales staff or field workers work off site during the different designated portions of the day, lunchtime versus the rest of the day, etc.

At 104 demographic data for the user and the workplace is determined or acquired, which may include user gender, age, job title and duties within the workplace, educational level, pay amount and basis (hourly with overtime conditions, salary, ownership interest in workplace, etc.), and similar data in aggregate or per-worker for the user and co-workers.

At 106 text content generated by the user from work tasks (emails, memoranda, correspondence, etc.), and also optionally from social networks such as Twitter® or Facebook®, is analyzed to generate a personality model that includes a sociability and organizational scores. (FACEBOOK is a trademark of Facebook, Inc. in the United States or other countries; TWITTER is a trademark of Twitter, Inc. in the United States or other countries.) The values of the scores reflect the relative strength of the respective tendencies. The higher the sociability score, the more likely that the user prefers to work with others, or in the presence of others, in completing work tasks; in contrast, the lower the sociability score, the higher the probability that the user prefers to work alone. The higher the organizational score, the stronger the indication that the user adheres closely to schedules, organizational hierarchy, routines and other organized behavior procedures; lower organizational scores indicate increased flexibility or plasticity in historic behavior, more willingness to diverge from schedules and normative procedures to complete a task.

At 108 a “morningness” or “eveningness” trait is selected for application to the user. This may be a function of analysis of historic task scheduling and completion rates, wherein selection of the eveningness trait is responsive to an indication that the user historically prefers to perform complex tasks other than during morning times. The selection may also be in response to analysis of the work task (and optionally social media) text content considered at 106, the user and workplace demographic and location data, or in response to assessing the answers to a survey designed to determine “morningness” or “eveningness” traits. An eveningness trait indicates that the user prefers to tackle complex, more difficult tasks during afternoon, night-time or other hours either after the morning hours or outside of conventional workday hours. For example, conventional circadian rhythm data applicable to the user (for the user's geographic area and time zone and demographic data, etc) may suggest that early afternoon should be a low-productive, down-time for the user: if historical or survey data indicates instead that this is a desired or productive work time for the user, aspects may responsively select the eveningness trait at 108. A user with an eveningness trait selection also generally tends to complete tasks in the late afternoon or evening, or otherwise during periods of low activity during conventional circadian rhythm profiles.

In response to an input of a workplace appointment scheduling request, at 110 the process extracts or otherwise identifies a verb of a main task of the scheduling request, via text analysis of the task name or description text data.

At 112 the main task verb is mapped onto a task verb of one of multiple cognitive domain taxonomy levels that each have different complexity level values relative to each other, and wherein each of the cognitive domain taxonomy levels is associated with unique verbs relative to others of the cognitive domain taxonomy levels. The different cognitive domain taxonomy levels are ranked from less complex to more complex relative to each other. Thus, for a first, less-complex level that must be mastered with respect to a given task subject matter before a second, more-complex level task is assigned to the same subject matter, the first level is assigned a lower complexity score than the second level.

Some aspects may construct training data sets for mapping by applying taxonomy processes against example tasks that are defined for job duty classifications for the user or co-workers within the workplace demographic data determined at 104. In some examples mapping the task main verb onto one of the task verbs listed above is via applying multi-class logistic regression.

At 114 the processes identifies a plurality of scheduling slots (time intervals) that are open (unassigned to other tasks) within an electronic calendar of the user and also occur prior to a maximum time boundary (deadline) for occurrence of the task. The deadline may be specified in text or other metadata of the task, or it may be a default value (for example, within the next week or fortnight or month or quarter, etc.)

If at 116 the complexity value of the cognitive domain taxonomy level mapped to the main task verb is lower than a minimum complexity value (threshold), then the task is a routine task amenable to scheduling at any time. Accordingly, in order to maintain higher availability for more complex tasks within a timeframe of the “morningness” or “eveningness” trait that is determined for the user (at 108), at 118 a first open slot within a timeframe of the other (opposite) of the “morningness” or “eveningness” trait determined for the user is selected for scheduling the task.

Else, at 120 each of the open slots is weighted differentially for selection for scheduling the task as a function of their different respective times of occurrence, wherein the weights are (i) higher the further they are from a present time, and in proportion to the value of the determined organizational score of the user personality model; and (ii) in proportion to a correlation of their projected relative level of co-worker occupancy to the personality model sociability value. Thus, at 122 an open slot within the timeframe of the “morningness” or “eveningness” trait determined for the user (at 108) that has a highest weighted value is selected for scheduling the task.

The automatic slot selections may match perfectly to each user's preferences. Accordingly, aspects incorporate a feedback component 124 that uses performance feedback to adjust slot selections and mappings to the user's personality traits and preferences, in an on-going learning from the received feedback. Thus, applied constraints used to identify available time slots at 114, or to select them at 118 and 122, are revised by the feedback component 124 as a function of conformance feedback collected from the user for similar tasks (for example, from other tasks wherein the main task verbs are similar within a cosine function comparison). The feedback component 124 may assign positive constraints or higher weights to enable selection of available slots within timeframes (days of week, etc.) near to positive recorded schedules as indicated in the feedback, and negative constraints or lower weights to reject times within timeframes that are close to negative recorded schedules (events that had negative feedback in terms of revising or rejecting the appointments). Identifying available slots or selecting a slot is then a function of solving as a function of the defined constraints. In addition, the user can give post-scheduling performance feedback (for example, how satisfying or productive the schedule was), which may be used by the feedback component 124 to adjust and revise future scheduling of similar events. In some aspects the feedback component 124 implements a matrix factorization model, for example as described in “Matrix Factorization Techniques for Recommender Systems,” Yehuda Koren, Robert Bell, Chris Volinsky, Computer, vol. 42, no. 8, pp. 30-37, August 2009, doi:10.1109/MC.2009.263.

In the aspect described in FIG. 5, more demanding tasks are scheduled in a preferred time period for the user as indicated by their morningness or eveningness trait. For users with the morningness trait (or having a value higher than eveningness trait value) the more complex tasks are generally scheduled in the morning, and routine or easy tasks are instead scheduled to the less-preferred evening hours. This preference is reversed for “night-owls,” those with a predominant eveningness trait.

Some aspects select the day of the week or other time for the open slot to create a delay or planning period indicated as appropriate by the determined organizational score. Thus, the appointment is set soon, with little time for advance preparation if the person is less organized, and later (with a longer elapse of time from a current time to the time of the selected open slot) to create a sufficiently long time for advance planning if the person is highly organized. Thus, the planning period, if any, is correlated to the value of organizational score or of some other underlying trait.

In some aspects, the personality model generated at 106 is based on personality traits defined in the “Five Factor Model” or “Big Five” personality trait model. In one illustrative but not limiting or exhaustive example the model generates scores based on one or more, or all, of neuroticism, agreeableness, conscientiousness, extraversion, and openness or intellect traits. Thus, the “morningness” or “eveningness” trait is selected for the user at 108 based on these values, wherein relatively high values in neuroticism, agreeableness or conscientiousness trait value results in selection of the morningness trait, and relatively high values in the extraversion, or openness traits result in selection of the eveningness trait.

In some aspects, the cognitive domain taxonomy levels and their respective unique matching verbs are defined in “Bloom's Taxonomy of the Cognitive Domain” (“Taxonomy of educational objectives: The classification of educational goals. Handbook I: Cognitive domain,” Bloom, B., Englehart, M. Furst, E., Hill, W., & Krathwohl, D. New York, Toronto: Longmans, (1956)). Thus, in some examples the cognitive domain taxonomy levels include the following, ranked from (i) through (vi) from lowest to most complex (and with corresponding lowest to most complex complexity values):

(i) “Knowledge,” wherein the user recalls or recognizes information, ideas, and principles in the approximate form in which they were learned. Knowledge task verb examples include: “write”, “list”, “label”, “name”, “state”, “collect”, “describe”, “quote”, “identify” and “define”.

(ii) “Comprehension,” wherein the user translates, comprehends, or interprets information based on prior learning. Comprehension task verb examples include: “explain”, “summarize”, “paraphrase”, “describe” and “illustrate”.

(iii) “Application,” wherein the user selects, transfers, and uses data and principles to complete a problem or task with a minimum of direction. Application task verb examples include: “use”, “compute”, “illustrate”, “solve”, “demonstrate”, “calculate”, “apply”, “complete” and “construct”.

(iv) “Analysis,” wherein the user distinguishes, classifies, and relates the assumptions hypotheses, evidence, or structure of a statement or question. Analysis task verb examples include: “analyze”, “categorize”, “compare”, “contrast”, “separate”, “explain”, “select”, “order”, “break down”, “correlate”, and “diagram”.

(v) “Synthesis,” wherein the user originates, integrates, and combines ideas into a product, plan or proposal that is new to him or her. Synthesis task verb examples include: “create”, “design”, “hypothesize”, “invent” and “develop”.

(vi) “Evaluation,” wherein the user appraises, assesses, or critiques on a basis of specific standards and criteria. Evaluation task verb examples include: “judge”, “recommend”, “critique” and “justify”.

The examples listed above are illustrative but not exhaustive examples of cognitive domain taxonomy levels and verbs associated uniquely therewith relative to others of the levels.

Thus, in some aspects, weighting open slots differentially for selection for scheduling a task (at 120, FIG. 4) includes generating constraints that depend on values of the Big Five profile traits of the user. For example, for people scoring high in the extroverted trait, the scheduler according to FIG. 4 creates a constraint for a time when it's likely to find people in the user's work location (for example, a couple of hours before or after a lunch time). For people scoring low in the extroverted trait, the schedule may create a constraint for times where the user's work location would be less crowded (for example, early morning right after the user arrives to the work location).

Selecting a “morningness” or “eveningness” trait, or assigning constraints and weights to the available slots, may further be a function of computing a circadian typology for the user as a function of correlation to determined personality trait values and demographic data.

Some aspects incorporate IBM Watson™ Personality Insights service, which provides an Application Programming Interface (API) that enables applications to derive insights into users from social media data, enterprise data, or other digital communication data, by using linguistic analytics to infer from text data personality and social characteristics, including the Big Five traits described above, as well as needs and other values. (IBM WATSON is a trademark of the International Business Machines Corporation (IBM) in the United States or other countries.)

Aspects of the present invention enable viewing a scheduling problem from a different perspective. By processing input data that includes a user's work environment data (for example, geographic work locations and hours, work locations attributes, etc.), personality model traits, morningness and eveningness traits and circadian profiles, aspects determine, based also on a nature or type of task, the best or optimal time slot (and optionally location) for a future suggested scheduling of the task, the suggestion that best fits the personality traits of the user and for engaging the nature or type of the task. By embracing and incorporating cognitive technologies, aspects of the present invention enable electronic calendars to move the focus from spotting free slots and remembering previous choices to maximizing user satisfaction and productivity based on user personality traits.

Aspects of the present invention provide or define a cognitive calendar assistant that suggests when and where to arrange tasks depending on skills that such tasks require, and the user's personality traits and circadian rhythm. With this information aspects suggest schedules where tasks are properly arranged, in the sense that at the scheduled days/times, the environment (e.g., work location and office hours) and skills required for the tasks are appropriate for the user, according to the determined user profile. In case of conflicts, aspects may automatically suggest reschedules for offending tasks.

Prior art personalized scheduling methods generally rely on finding free spots in a user's calendar, suggesting (possibly a subset of) them, and recording the user choice for future use. Such approaches are problematic, as they may generate a schedule that is not suitable for a user's personality. By adopting a cognitive approach, aspects of the present invention suggest schedules tailored to a user's working habits, as suggested by the inferred user's profile.

Calendar assistant aspects of the present invention may be integrated into e-mail clients such as Lotus Notes®, and mobile or desktop calendar applications (internet, network or desktop based), such as Google Calendar™. (LOTUS NOTES is a trademark of the International Business Machines Corporation (IBM) in the United States or other countries; GOOGLE CALENDAR is a trademark of Google, Inc. in the United States or other countries.) This integration enables the assistant to collect information about how the user writes e-mails, and how the user interacts with other humans, in order to characterize the user according to the Big Five personality model.

Aspects may use gathered text content information as input to an IBM WATSON Personality Insights (“WPI”) service, which outputs the Big Five characterization trait values of the user. Once the WPI computes the personality profile trait values, aspects may use these values to identify a user's predominant morningness or eveningness trait, or other customized circadian rhythm profile, accordingly to the correlations between Big Five personality domains and circadian typology.

Examples of implementations of the aspect of FIG. 4 include the following numbered items.

(1.) User 1 wants to schedule an appropriate time and day of the week for writing the introduction to a research article, and inputs a task title of “Write introduction section for research paper,” and optionally a description, estimated duration of the time to be allocated to complete the task (two hours), and possible time intervals where it can be allocated (for example, the task must be completed in at most two days). The title verb “write” is identified as the main task verb at 108, and mapped at 112 as matching the verbs of an “Application” taxonomy level category, either exactly wherein “write” is listed in the associated verbs, or recognized as falling within a category of task verbs for this level that “apply existing knowledge to novel situations.”

User 1 workplace and demographic data determined at 102 and 104 indicates that the user works in an office, in a usual nine to five schedule, and tends to be “an early bird.” Personality trait scores or values determined at 106 include high scores in consciousness, extroversion, and agreeableness traits, which leads to a determining a morningness trait for the user at 108. The high consciousness score denotes a preference for organized behavior, and in response a constraint is generated at 120 so the task is not scheduled too soon within a possible time range interval, thus giving User 1 time to plan how to perform the task. Generally, the higher the consciousness score the further a scheduled slot should be from a present time, in proportion to the value of the determined organizational score of the user personality model.

In response to the high extroverted score, a constraint is added at 120 to select a time slot when User 1 is likely to be in company of colleagues, and the value of the constraint is further strengthened (increased) by a collaborative nature trait score of User 1. This would suggest office hours with peak co-worker occupancy and associated assistance levels, for example, a couple of hours before or after lunchtime.

In response to the complexity value of the mapped Application taxonomy level category meeting the minimum complexity threshold at 116, a constraint is added at 120 to limit possible time slots to morning hours that fall within a specified timeframe of the morningness trait determined as preferred or predominant for User 1 at 108.

Thus, at 122 a 10:00 AM morning slot is selected for this task for User 1 as a function of meeting the constraints or weighting described above: it is toward the end of the allowable time for completion (two days from now, to enable planning and organization by User 1), during hours with the timeframe of the morningness trait constraint, meets a peak co-worker occupancy constraint (late morning slots have highest occupancy in the office relative to early morning slots prior to 10:00 AM), and satisfied a completion time constraint (it is two hours prior to a lunch break, thereby assuring enough time to complete the task).

At 124 the selected slot may be varied as needed in response to recorded conformance feedback for similar tasks: for example, it may be moved back to 9:45 AM in response to historic calendar appointment adjustments made to other (iii) application taxonomy level category tasks by User 1. After the scheduler suggestion is posted to User 1, the user gives conformance feedback at 124 (accepts or rejects the scheduled time slot), which is recorded into historic data, which may include another iteration at 114 to select another slot in case of a rejection.

Feedback at 124 may also be provided by User 1 upon accomplishing the task at the scheduled time, for example marking it as completed with performance feedback; confirming that entire allocated time was used, or only portion thereof, or that more time was needed; more or less advance planning time required or desired; time of day was satisfactory, or earlier or later time desired for future similar tasks, which will be associated with any other (iii) application taxonomy level categories tasks for User 1. This data may also be used to change the determined morningness trait to a predominant eveningness trait for User 1, overall or just for (iii) Application taxonomy level category tasks, etc.

(2.) User 2 wishes to schedule a task of searching for prior art relevant to a patent application disclosure. Personality trait scores determined at 106 include a high score in extroversion, which results in a determination of the morningness trait as predominant for User 2 at 108, due to a high correlation with extroverted personalities, and/or based on workplace and demographic data determined at 102 and 104 that indicates early bird tendencies for User 2. The main verb determined for the task at 110 is “search,” which maps to (matches) a verb associated with an “Understanding” taxonomy level category at 112. A task deadline input specifies “by next week”. As extroverted people nurture from social interactions, they work best in a crowded environment. In particular, an extrovert involved in an understanding task will benefit from the interaction with peers that might clarify doubts and collaborate with the person doing the job. Accordingly, constraints or weighting are set to allocate the task to crowded office hours, preferable in the morning (since the person is an early bird). The first available morning before the deadline, a little before lunch (say, 10:00 AM) is selected as a good time to perform the task and accordingly scheduled at 122.

(3.) Employee (User 3) that scores high in “openness to change” has to do a survey, which maps to a “remember” taxonomy level category. User 3 is determined to have a predominant eveningness trait. The high “openness to change” trait score indicates that User 3 does well at creative tasks. Since a survey isn't an example of creative work, it won't be the kind of task that User 3 is likely to highly enjoy, which may enhance the value of the complexity or difficulty rating of the “remember” taxonomy level category for this user. Accordingly, the calendar allocates the task in evening hours, when User 3 will perform better (for example, the last task before leaving at 4:00 PM), which also helps to ensure that User 3 leaves the office with a sense of accomplishment. In terms of the date, the process schedules the task as soon as possible at 122 (as allowed by conflicting tasks and deadlines constraints) so as to avoid procrastination.

(4.) Committee member (User 4) has to organize a conference schedule. User 4 scores high in “agreeableness” and low in “neuroticism”, which is used to determine a predominant morningness trait for User 4. “Organizing” is identified as the main verb for the task, which is mapped to an “apply knowledge” taxonomy level category, and as requiring people skills. This means that it's a task that User 4 is likely to do well, because it matches the skills correlated to the high “agreeableness” personality trait score. In addition, User 4 scores high in “assertive” and “self-confident” personality metrics. The process determines that the mapped task need not be strongly correlated with the morningness trait, as the profile data indicates that it may be performed equally well by User 4 in morning or evening times, so the weighting or constraint of the morningness trait is reduced to zero for slot selection. So to avoid cluttering the more valuable morning slots, the process allocates the task in to an evening slot (for example, evening just after lunch, at 1:30 or 2:00 PM), on a date selected to ensure enough time for coordinating efforts (including attendance) among multiple, different people.

(5.) An employee (User 5) must review and evaluate a grant proposal. User 5 scores high on consciousness, and low on extroversion; and has a predominant eveningness trait. The “evaluating” main task verb maps to an “evaluation” taxonomy level category, which requires thorough analysis and methodical work and is therefore, assigned a complexity value above a minimum complexity threshold. This generates scheduling constraints to limit possible slots to evening slots, in order to conform to the predominant eveningness trait. User 5 scores low on extroversion, so would rather work alone on this task. Therefore the process would schedule the task for the late evening (say, 4:00 or 5:00 PM) when office occupancy is low. User 5 also scores high in consciousness (a trait denoting methodic behavior and need for preparation), so the date selected for the task is delayed for a number of days (up to deadline and busy slots in the calendar), so that User 5 has time to perform any necessary preliminary and setup tasks.

(6.) User 6 needs to schedule an image classification task that involves classifying each of a set of images as depicting people or not. The main task verb is determined to be “labeling”, which maps to a “knowledge” taxonomy level category having a low difficulty or complexity value, assuming that the classification task is as not demanding as to concentration for the abilities determined in profile data for User 6. User 6 also scores low in openness to change and low in agreeableness, and has an eveningness trait. Since the “openness to change” trait is associated to exploring new ideas and creative thinking, a low score in that trait means that User 6 is well suited to the task and is unlikely to find it tedious. As a function of the low complexity of the task and the alignment with the personality attribute scores of User 6, the task is allocated to morning hours. User 6 also scores low in agreeableness, so would rather work alone on this task, so an earlier morning hour having a lower co-worker occupancy loading or interaction level is selected, for example, the first slot of the workday at 9:00 AM.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for a calendar scheduler that automatically schedules a future task appointment by correlating task attributes to user personality traits, the method comprising executing on a computer processor the steps of:
selecting one of a morningness trait and an eveningness trait for application to a user as a function of personality trait data for the user, wherein selection of the eveningness trait is responsive to an indication in the personality trait data that the user prefers to perform complex tasks at times other than during morning times;
mapping a main task verb of an appointment request to a matching verb that is associated with one of a plurality of cognitive domain taxonomy levels, wherein the cognitive domain taxonomy levels have different complexity values relative to each other, and wherein each of the cognitive domain taxonomy levels is associated with different verbs for matching to the main task verb; and
in response to the complexity value of the cognitive domain taxonomy level associated with the matching verb that is mapped to the main task verb meeting a minimum complexity threshold, selecting an open slot within an electronic calendar of the user for scheduling the appointment request as a function of a correlation of co-worker occupancy of a workplace of the user during the selected open slot to a preference of the user to work with co-workers, and to a time of the selected open slot within a timeframe of the selected morningness or eveningness trait.

2. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the steps of selecting the one of the morningness and eveningness traits for application to the user, mapping the main task verb of the appointment request to the matching verb associated with the one of the cognitive domain taxonomy levels, and in response to the complexity value of the cognitive domain taxonomy level associated with the matching verb mapped to the main task verb meeting the minimum complexity threshold selecting the open slot within the electronic calendar of the user for scheduling the appointment request.

3. The method of claim 2, wherein the computer-readable program code is provided as a service in a cloud environment.

4. The method of claim 1, further comprising:
generating, as a function of analyzing user text content, a sociability score for the user that has a first value signifying that the user likes to be in the company of co-workers as a function of high values of agreeableness or extroversion traits, and a different second value signifying that the user likes to work alone as a function of low values of agreeableness or extroversion traits.

5. The method of claim 1, further comprising:
generating, as a function of analyzing user text content, an organizational score for the user that has a value that increases in proportion to a historic tendency of the user to adhere closely to schedules and organizational behavior procedures, and decreases in proportion to a historic tendency of the user to diverge from the schedules or the organizational behavior procedures; and
wherein the step of selecting the open slot is further a function of a correlation of an elapse of time from a current time to the time of the selected open slot to a value of the determined organizational score.

6. The method of claim 1, further comprising:
in response to the complexity value of the cognitive domain taxonomy level that is associated with the matching verb mapped to the main task verb not meeting the minimum complexity threshold, selecting another open slot within the user electronic calendar for scheduling the appointment request that is within a timeframe of an other of the morningness or eveningness trait that is not selected for the user.

7. The method of claim 1, further comprising:
generating, as a function of analyzing user text content, the personality trait data for the user as comprising at least one of neuroticism, agreeableness, conscientiousness, extroversion, and openness personality trait scores; and
wherein the step of selecting the one of the morningness and eveningness trait for application to the user as the function of personality trait data comprises:
selecting the morningness trait in response to relatively high values in at least one of the neuroticism, the agreeableness and the conscientiousness personality trait scores; and
selecting the eveningness trait in response to relatively high values in at least one of the extraversion and the openness personality trait scores.

8. The method of claim 1, wherein the plurality of cognitive domain taxonomy levels comprises a progressively ranked order of knowledge, comprehension, application, analysis, synthesis and evaluation taxonomy levels.

9. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
selects one of a morningness trait and an eveningness trait for application to a user as a function of personality trait data for the user, wherein selection of the eveningness trait is responsive to an indication in the personality trait data that the user prefers to perform complex tasks at times other than during morning times;
maps a main task verb of an appointment request to a matching verb that is associated with one of a plurality of cognitive domain taxonomy levels, wherein the cognitive domain taxonomy levels have different complexity values relative to each other, and wherein each of the cognitive domain taxonomy levels is associated with different verbs for matching to the main task verb; and
in response to the complexity value of the cognitive domain taxonomy level associated with the matching verb that is mapped to the main task verb meeting a minimum complexity threshold, selects an open slot within an electronic calendar of the user for scheduling the appointment request as a function of a correlation of co-worker occupancy of a workplace of the user during the selected open slot to a preference of the user to work with co-workers, and to a time of the selected open slot within a timeframe of the selected morningness or eveningness trait.

10. The system of claim 9, wherein the processor executes the program instructions stored on the computer-readable storage medium via the computer readable memory and thereby further:
generates, as a function of analyzing user text content, a sociability score for the user that has a first value signifying that the user likes to be in the company of co-workers as a function of high values of agreeableness or extroversion traits, and a different second value signifying that the user likes to work alone as a function of low values of agreeableness or extroversion traits.

11. The system of claim 9, wherein the processor executes the program instructions stored on the computer-readable storage medium via the computer readable memory and thereby further:
generates, as a function of analyzing user text content, an organizational score for the user that has a value that increases in proportion to a historic tendency of the user to adhere closely to schedules and organizational behavior procedures, and decreases in proportion to a historic tendency of the user to diverge from the schedules or the organizational behavior procedures; and
selects the open slot as a function of a correlation of an elapse of time from a current time to the time of the selected open slot to a value of the determined organizational score.

12. The system of claim 9, wherein the processor executes the program instructions stored on the computer-readable storage medium via the computer readable memory and thereby further:
in response to the complexity value of the cognitive domain taxonomy level that is associated with the matching verb mapped to the main task verb not meeting the minimum complexity threshold, selects another open slot within the user electronic calendar for scheduling the appointment request that is within a timeframe of an other of the morningness or eveningness trait that is not selected for the user.

13. The system of claim 9, wherein the processor executes the program instructions stored on the computer-readable storage medium via the computer readable memory and thereby further:
generates, as a function of analyzing user text content, personality trait data for the user that comprises at least one of neuroticism, agreeableness, conscientiousness, extroversion, and openness personality trait scores; and
selects the one of the morningness and eveningness trait for application to the user by:
selecting the morningness trait in response to relatively high values in at least one of the neuroticism, the agreeableness and the conscientiousness personality trait scores; and
selecting the eveningness trait in response to relatively high values in at least one of the extraversion and the openness personality trait scores.

14. The system of claim 9, wherein the plurality of cognitive domain taxonomy levels comprises a progressively ranked order of knowledge, comprehension, application, analysis, synthesis and evaluation taxonomy levels.

15. A computer program product for a calendar scheduler that automatically schedules a future task appointment by correlating task attributes to user personality traits, the computer program product comprising:
a computer readable storage medium having computer readable program code embodied therewith, wherein the computer readable storage medium is not a transitory signal per se, the computer readable program code comprising instructions for execution by a processor that cause the processor to:
select one of a morningness trait and an eveningness trait for application to a user as a function of personality trait data for the user, wherein selection of the eveningness trait is responsive to an indication in the personality trait data that the user prefers to perform complex tasks at times other than during morning times;
map a main task verb of an appointment request to a matching verb that is associated with one of a plurality of cognitive domain taxonomy levels, wherein the cognitive domain taxonomy levels have different complexity values relative to each other, and wherein each of the cognitive domain taxonomy levels is associated with different verbs for matching to the main task verb; and
in response to the complexity value of the cognitive domain taxonomy level associated with the matching verb that is mapped to the main task verb meeting a minimum complexity threshold, select an open slot within an electronic calendar of the user for scheduling the appointment request as a function of a correlation of co-worker occupancy of a workplace of the user during the selected open slot to a preference of the user to work with co-workers, and to a time of the selected open slot within a timeframe of the selected morningness or eveningness trait.

16. The computer program product of claim 15, wherein the computer readable program code instructions for execution by the processor further cause the processor to:
generate, as a function of analyzing user text content, a sociability score for the user that has a first value signifying that the user likes to be in the company of co-workers as a function of high values of agreeableness or extroversion traits, and a different second value signifying that the user likes to work alone as a function of low values of agreeableness or extroversion traits.

17. The computer program product of claim 15, wherein the computer readable program code instructions for execution by the processor further cause the processor to:
generate, as a function of analyzing user text content, an organizational score for the user that has a value that increases in proportion to a historic tendency of the user to adhere closely to schedules and organizational behavior procedures, and decreases in proportion to a historic tendency of the user to diverge from the schedules or the organizational behavior procedures; and
select the open slot as a function of a correlation of an elapse of time from a current time to the time of the selected open slot to a value of the determined organizational score.

18. The computer program product of claim 15, wherein the computer readable program code instructions for execution by the processor further cause the processor to:
in response to the complexity value of the cognitive domain taxonomy level that is associated with the matching verb mapped to the main task verb not meeting the minimum complexity threshold, select another open slot within the user electronic calendar for scheduling the appointment request that is within a timeframe of an other of the morningness or eveningness trait that is not selected for the user.

19. The computer program product of claim 15, wherein the computer readable program code instructions for execution by the processor further cause the processor to:
generate, as a function of analyzing user text content, personality trait data for the user that comprises at least one of neuroticism, agreeableness, conscientiousness, extroversion, and openness personality trait scores; and
select the one of the morningness and eveningness trait for application to the user by:
selecting the morningness trait in response to relatively high values in at least one of the neuroticism, the agreeableness and the conscientiousness personality trait scores; and
selecting the eveningness trait in response to relatively high values in at least one of the extraversion and the openness personality trait scores.

20. The computer program product of claim 15, wherein the plurality of cognitive domain taxonomy levels comprises a progressively ranked order of knowledge, comprehension, application, analysis, synthesis and evaluation taxonomy levels.
